(19) United States
(12) Patent Application Publication
(10) Pub. No.: US 2008/0024476 A1
(43) Pub. Date: Jan. 31, 2008

(54) DISPLAY DEVICE AND DRIVING METHOD THEREOF

(75) Inventors: Joon-Hoo CHOI, Seoul (KR); Kyuha CHUNG, Seoul (KR); Nam-Deog KIM, Yongin-si, Gyeonggi-do (KR); Byung-Seong BAE, Suwon-si, Gyeonggi-do (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/677,349

(22) Filed: Feb. 21, 2007

(30) Foreign Application Priority Data
Feb. 21, 2006 (KR) 10-2006-0016592

(51) Int. Cl. G06F 3/038

(52) U.S. Cl. 345/207

(57) ABSTRACT

A display device and a driving method thereof include a plurality of light emitting elements arranged in a matrix form, for emitting different colors of light from each other, a plurality of driving transistors which supply a driving current to the light emitting elements, and photosensors which sense the amount of light emitted from the light emitting elements and produce a sense signal according to the sensed amount of light, the photosensors being positioned at a space between the plurality of light emitting elements.

This application claims priority to Korean Patent Application No. 10-2006-0016592, filed on Feb. 21, 2006, and all the benefits accruing therefrom under 35 U.S.C. §119, the contents of which in its entirety are herein incorporated by reference.

### BACKGROUND OF THE INVENTION

(a) Field of the Invention

The present invention relates to a display device and a method thereof, and more particularly, to a display device having a photosensing function.

(b) Description of the Related Art

Recently, as thin and lightweight monitors and television sets have been required, the cathode ray tube (“CRT”) is being replaced by a liquid crystal display (“LCD”).

However, the liquid crystal display, which serves as a light receiving and emitting device, requires a backlight, and has many problems in terms of response speed, viewing angle, power consumption, etc. An organic light emitting diode (“OLED”) display has been recently highlighted as a display device to solve such problems.

The organic light emitting diode display includes two electrodes and a light emitting layer disposed therebetween. Electrons injected from one of the electrodes and holes injected from the other electrode are combined in the light emitting layer to form excitons, and the excitons release energy and cause light to be emitted. The energy released by the excitons electrically excites phosphorous organic materials to emit light and display an image. As a self-emitting apparatus with low power consumption, a wide viewing angle and a high pixel response speed, the organic light emitting diode display can easily display a high quality moving image.

The organic light emitting diode display includes organic light emitting diodes and thin film transistors (“TFTs”) which drive the organic light emitting diodes. The thin film transistors are classified as either polysilicon thin film transistors or amorphous silicon thin film transistors, according to types of active layers. Due to several advantages thereof, the organic light emitting diode display employing the polysilicon thin film transistors has generally been used. However, manufacturing processes for the polysilicon thin film transistors are complex, and thus production costs increase. In addition, it is difficult to obtain a wide screen by using the organic light emitting diode display devices when employing polysilicon thin film transistors.

By using the organic light emitting diode display employing the amorphous silicon thin film transistors, a wide screen can be easily obtained. In addition, the number of production processes thereof is relatively smaller than that of the organic light emitting diode display device employing the polysilicon thin film transistors.

However, as a positive DC voltage is continuously supplied to control terminals of the amorphous silicon thin film transistors, the threshold voltage of the amorphous silicon thin film transistors shifts. Even though the same control voltage is applied, non-uniform current flows through the organic light emitting diodes, so that the luminance of the organic light emitting diode display is lowered and the image quality thereof deteriorates. This results in a shortened lifetime of the organic light emitting diode display.

Accordingly, various pixel circuits for preventing image degradation through compensation of the variation of the threshold voltage have been suggested. However, since most of the suggested pixel circuits have several thin film transistors and capacitors as well as additional wiring, the suggested pixel circuits may cause a reduced pixel aperture ratio.

Therefore, a desire still exists to prevent the degradation of image quality by compensating for the shift of the threshold voltage of an amorphous silicon thin film transistor.

### BRIEF SUMMARY OF THE INVENTION

According to one exemplary embodiment of the present invention, there is provided a display device, including a plurality of light emitting elements arranged in a matrix form for emitting different colors of light from each other, a plurality of driving transistors which supply a driving current to the light emitting elements, and photosensors which sense the amount of light emitted from the light emitting elements and produce a sense signal according to the sensed amount of light. The photosensors are positioned at a space between the plurality of light emitting elements.

The photosensors may each be positioned at a substantially equal distance from four of the plurality of light emitting elements.

The photosensors may each be positioned at a substantially equal distance from two of the plurality of light emitting elements.

The display device may further include a light guide member for transmitting light from the light emitting elements to the photosensors.

The light guide member may include a common electrode formed on the light emitting elements.

The common electrode may be one of transparent and opaque according to an emission type of the display device.

The plurality of light emitting elements may be disposed intermediate the light guide member and the photosensors.

The display device may further include a light shielding part for shielding light entering the photosensors.

The photosensors may each include a sensing transistor for forming a photocurrent according to the light emission of the light emitting element.

The display device may further include a plurality of first capacitors for charging an image data voltage corresponding to the driving current, and a plurality of second capacitors for charging a sensing reference voltage and discharging a predetermined voltage corresponding to the photocurrent.

The display device may further include a plurality of first switching transistors for transmitting the image data voltage to the first capacitors and the driving transistor in response to a scanning signal, and a plurality of second switching transistors for transmitting the sensing reference voltage to the second capacitors and the sensing transistor in response to the scanning signal.

The display device may further include a plurality of scanning signal lines connected to the first and second switching transistors for connecting the scanning signal, a plurality of image data lines connected to the first switching transistors for transmitting the image data voltage, and a plurality of sensing data lines connected to the second switching transistors for transmitting the sensing reference voltage.

The display device may further including a luminance detector connected to the sensing data lines to supply the sensing reference voltage to the sensing data lines, and to detect the magnitude of the voltage charged in the second capacitor to produce luminance information of the light emitting elements.

According to another exemplary embodiment of the present invention, there is provided a method of driving a display device, the display device including first and second light emitting element groups each including at least one light emitting element, a driving transistor connected to the light emitting element, and at least two photosensors neighboring the light emitting element, the method including: applying a data voltage to the driving transistor; supplying a driving current depending on the data voltage to the light emitting element through the driving transistor to ruminate the first light emitting element group among the plurality of light emitting elements; producing sensing signals according to the light emission of the first light emitting element group by each of the photosensors; displaying an image by the light emission of the second light emitting element group according to image information; and detecting a luminance corresponding to the sensing signals produced from each of the photosensors, and compensating an image signal by comparison between the detected luminance and a target luminance.

The first light emitting element group may include at least one light emitting element.

The method may further include averaging at least two of the sensing signals to detect the corresponding luminance.

The displaying of an image and the producing of sensing signals may be simultaneously performed.

The displaying of an image and the producing of sensing signals may be performed in an alternating fashion.

The method may further include: luminating a third light emitting element group including at least one of the light emitting elements included in the second light emitting element group; producing sensing signals according to the light emission of the first light emitting element group by each of the photosensors; and detecting a luminance corresponding to the sensing signals produced from each of the photosensors, and compensating an image signal by comparison between the detected luminance and a target luminance.

### BRIEF DESCRIPTION OF THE DRAWINGS

The present invention will become more apparent by describing preferred exemplary embodiments thereof in more detail with reference to the accompanying drawings, in which:

FIG. 1 shows a block diagram of an organic light emitting diode display according to one exemplary embodiment of the present invention;

FIG. 2 shows an equivalent circuit diagram of a pixel of an organic light emitting diode display according to one exemplary embodiment of the present invention;

FIG. 3 is a cross-sectional view showing one example of a partial cross-section of an organic light emitting diode display according to one exemplary embodiment of the present invention;

FIG. 4 is a schematic diagram of an organic light emitting diode of an organic light emitting diode display according to one exemplary embodiment of the present invention;

FIG. 5 is a partial schematic plan view layout of an organic light emitting diode display according to one exemplary embodiment of the present invention;

FIG. 6 is an equivalent circuit diagram of an example of one pixel of an organic light emitting diode display according to one exemplary embodiment of the present invention;

FIG. 7 is a cross-sectional view showing the organic light emitting diode display as shown in FIG. 5, taken along line VII-VII; and

FIG. 8 is a partial schematic plan view layout of an organic light emitting diode display according to another exemplary embodiment of the present invention.

### DETAILED DESCRIPTION OF THE INVENTION

The present invention will be described more fully hereinafter with reference to the accompanying drawings, in which preferred exemplary embodiments of the present invention are shown. As those skilled in the art would realize, the described exemplary embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

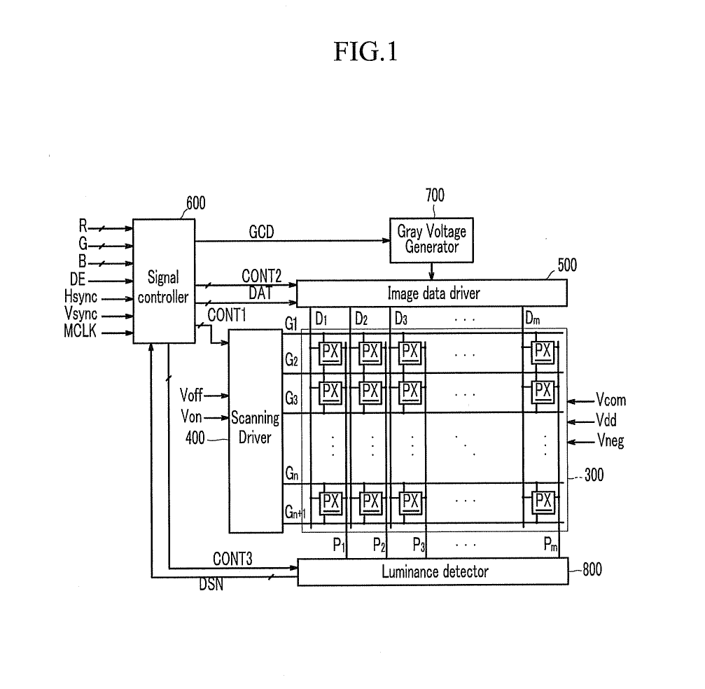

First, referring to FIG. 1, an organic light emitting display according to an exemplary embodiment of the present invention will be described.

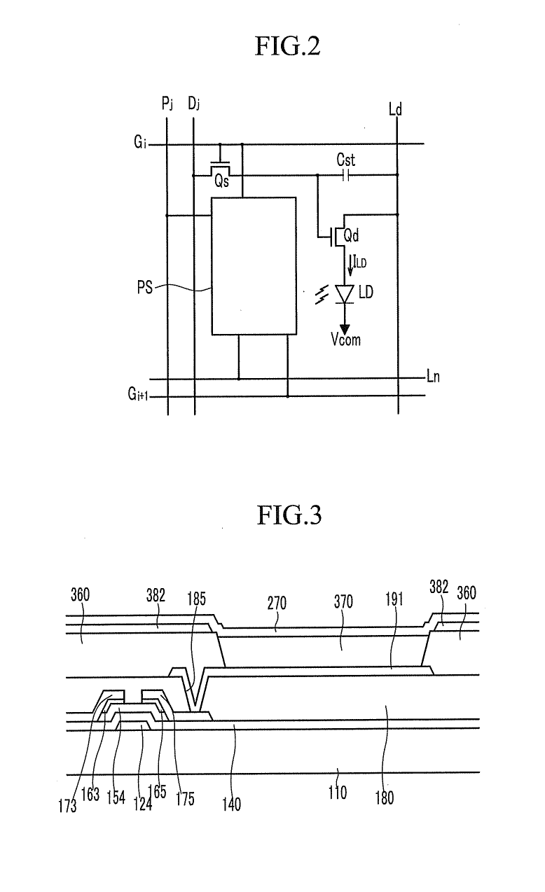

FIG. 1 shows a block diagram of an organic light emitting diode display according to one exemplary embodiment of the present invention FIG. 2 shows an equivalent circuit diagram of a pixel of an organic light emitting diode display according to one exemplary embodiment of the present invention.

As shown in FIG. 1, the organic light emitting diode display according to an exemplary embodiment of the present invention includes a display panel 300, a scanning driver 400, an image data driver 500, a luminance detector 800 and a gray voltage generator 700 connected to the image data driver 500, and a signal controller 600 controlling the above-described elements.

The display panel 300, in an equivalent circuital view, includes a plurality of signal lines G₁-Gₙ₊₁, D₁-Dₘ, P₁-Pₘ, Ld and Ln, and a plurality of pixels PX connected thereto and arranged substantially in a matrix form.

The signal lines G₁-Gₙ₊₁, D₁-Dₘ, P₁-Pₘ include a plurality of scanning signal lines G₁-Gₙ₊₁ which transmit scanning signals, a plurality of image data lines D₁-Dₘ which transmit image data voltages, and a plurality of sensing data lines P₁-Pₘ which transmit sensing reference voltages. The scanning signal lines G₁-Gₙ₊₁ extend substantially in a row direction and are substantially parallel to each other, while the image data lines D₁-Dₘ and the sensing data lines P₁-Pₘ extend substantially in a column direction and are substantially parallel to each other, as illustrated in FIG. 1.

The signal lines include driving voltage lines Ld which transmit driving voltages Vdd and control voltage lines Ln which transmit a control voltage Vneg, and extend in a column or row direction, respectively, as illustrated in FIG. 2.

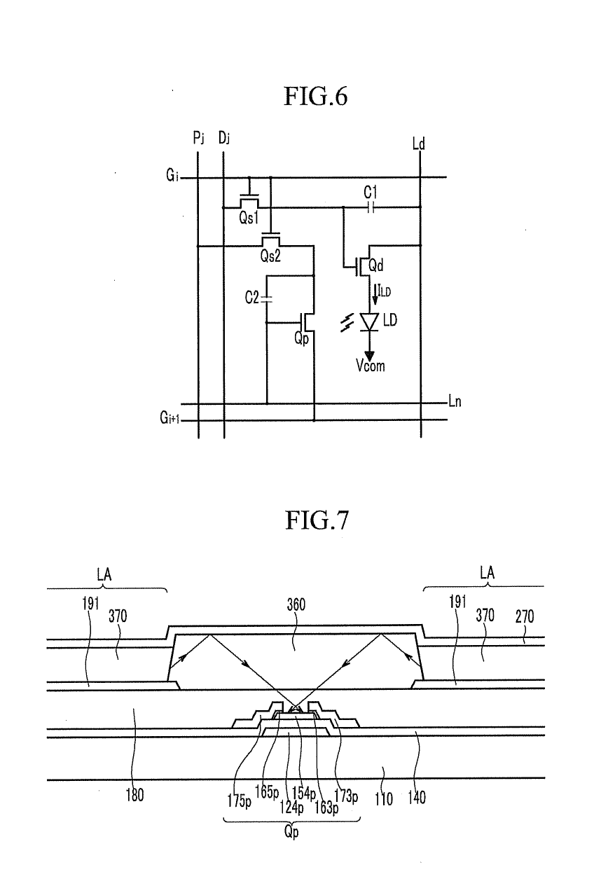

Referring to FIG. 2, each pixel PX, for example a pixel connected to the scanning signal line Gᵢ of the i-th pixel row and the image data line Dⱼ and sensing data line Pⱼ of the j-th pixel row, includes an organic light emitting diode LD, a driving transistor Qd, a capacitor Cst, a photosensors PS, and switching transistors Qs (e.g., first and second switching transistors Qs1 and Qs2 in FIG. 6).

The driving transistors Qd are three-terminal elements with a control terminal connected to the switching transistors Qs and the capacitor Cst, an input terminal connected to the driving voltage line Ld applied with the driving voltage Vdd, and an output terminal connected to the organic light emitting diode LD.

The switching transistors Qs are also three-terminal elements, with a control terminal and an input terminal connected to the scanning signal line Gᵢ and the image data line Dⱼ, respectively, and an output terminal connected to the capacitor Cst and the driving transistor Qd.

The capacitor Cst is connected between the switching transistor Qs and the driving voltage Vdd, and is charged with a data voltage from the first switching transistor and maintains the data voltage for a predetermined time.

The anode and cathode of the organic light emitting diode LD are connected to the driving transistor Qd and a common voltage Vcom, respectively. The organic light emitting diode LD emits light at an intensity which varies according to the magnitude of a current I_{LD} supplied by the driving transistor Qd to thus display images. The magnitude of the current I_{LD} is dependent upon the magnitude of a voltage Vgs between the control terminal and output terminal of the driving transistor Qd.

The switching transistors Qs and the driving transistor Qd include n-channel field effect transistors (“FETs”) made of amorphous silicon or polysilicon. However, any one of these transistors Qs and Qs may include p-channel field effect transistors in alternative exemplary embodiments. In this case, the p-channel electric field transistors and the n-channel field effect transistors are complementary to each other, and thus the operation, voltage and current of the p-channel field effect transistors are opposite to those of the n-channel field effect transistors.

The photosensor PS is connected to the scanning signal line Gᵢ, the sensing data line Pⱼ, the control voltage line Ln and the scanning signal line Gᵢ₊₁ of the (i+1)-th pixel row (hereinafter referred to as the next scanning signal line). The photosensor PS receives light emitted from the organic light emitting diode LD to form a photocurrent, and sends the photocurrent to the output terminal according to a voltage difference between the input terminal and the output terminal.

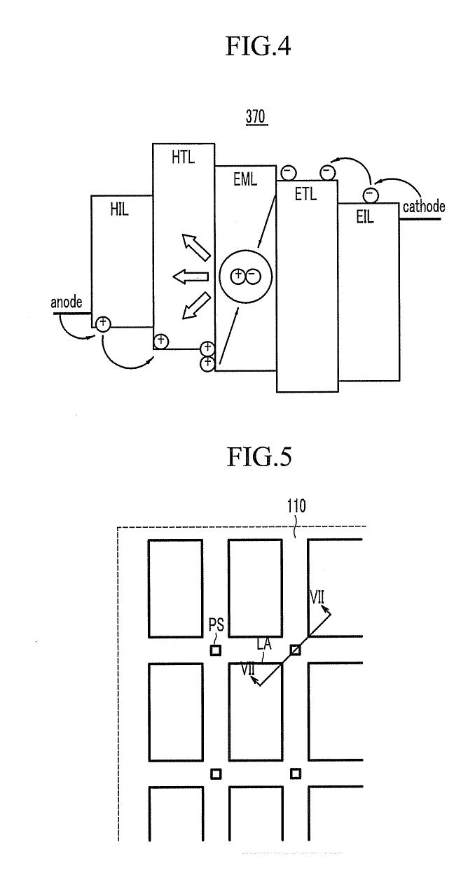

Thereafter, the structure of the driving transistor Qd and the organic light emitting diode LD of the organic light emitting diode display as shown in FIG. 2 will be described in more detail with reference to FIGS. 3 and 4.

FIG. 3 is a cross-sectional view showing one example of a partial cross-section of a driving transistor and of an organic light emitting diode of the one pixel of the organic light emitting diode display as shown in FIG. 2 FIG. 4 is a schematic diagram of an organic light emitting diode of an organic light emitting diode display according to one exemplary embodiment of the present invention.

A control terminal electrode 124 is formed on an insulating substrate 110. The control terminal electrode 124 is made of an aluminum-based metal such as aluminum (Al) and aluminum alloys, silver-based metals such as silver (Ag) and silver alloys, copper-based metals such as copper (Cu) and copper alloys, molybdenum-based metals such as molybdenum (Mo) and molybdenum alloys, chromium (Cr), titanium (Ti), tatalum (Ta), and so on. However, the control terminal electrode 124 may have a multilayered structure including two conductive layers (not shown) having different physical properties. One of the conductive layers is made of a metal having low resistivity, such as an aluminum-based metal, a silver-based metal, a copper-based metal, etc., so as to reduce signal delay or voltage drop. On the other hand, the other conductive layer is made of a material such as a molybdenum-based metal, chromium, titanium, and tatalum, which has excellent physical, chemical and electrical contact characteristics with other materials such as indium tin oxide (“ITO”) and indium zinc oxide (“IZO”). Good exemplary combinations of such layers include a combination of a chromium lower layer and an aluminum (alloy) upper layer and a combination of an aluminum (alloy) lower layer and a molybdenum (alloy) upper layer. However, the control terminal electrode 124 may be made of various kinds of metals and conductors. The control terminal electrode 124 is tapered with respect to a surface of the substrate 110, and the inclination angle thereof ranges from about 30° to about 80°.

An insulating layer 140 made of silicon nitride (“SiNx”) is formed on the control terminal electrode 124.

A semiconductor 154 made of hydrogenated amorphous silicon (“a-Si”) or polycrystalline silicon (“polysilicon”) is formed on the insulating layer 140. A pair of ohmic contacts 163 and 165 made of silicide or n+ hydrogenated a-Si heavily doped with an n-type impurity are formed on the semiconductor 154. The lateral sides of the semiconductor 154 and the ohmic contacts 163 and 165 are tapered, and the inclination angles thereof are in a range between about 30° and about 80°.

An input terminal electrode 173 and an output terminal electrode 175 are formed on the ohmic contact 163 and 165, respectively, and the insulating layer 140. The input terminal electrode 173 and the output terminal electrode 175 are made of chromium- and molybdenum-based metals or refractory metals such as tantalum and titanium, and may have a multilayered structure including a lower layer (not shown) made of a refractory metal or the like and an upper layer of a low resistivity material disposed thereon. Examples of the multilayered structure include a double layer including a chromium or molybdenum (alloy) lower layer and an aluminum upper layer, and a triple layer including a molybdenum (alloy) lower layer, an aluminum (alloy) intermediate layer and a molybdenum (alloy) upper layer. Like the control terminal electrode 124, the lateral sides of the input terminal electrodes 173 and the output terminal electrodes 175 are tapered, and the inclination angles thereof ranges from about 30° to about 80°.

The input terminal electrode 173 and the output terminal electrode 175 are separated from each other, and are disposed at both sides of the control terminal electrode 124. The control terminal electrode 124, the input terminal electrode 173 and the output terminal electrode 175 define a driving transistor Qd along with the semiconductor 154, and its channel is formed on the semiconductor 154 between the input terminal electrode 173 and the output terminal electrode 175.

The ohmic contacts 163 and 165 are interposed only between the underlying semiconductor 154 and the overlying input terminal electrode 173 and the overlying output terminal electrode 175 thereon to reduce the contact resistance therebetween. The semiconductor 154 includes an exposed portion, which is not covered with the input terminal electrode 173 and the output terminal electrode 175.

A passivation layer 180 is formed on the input terminal electrode 173, the output terminal electrode 175, the exposed portion of the semiconductor 154 and the insulating layer 140. The passivation layer 180 is made of an inorganic insulating material, such as silicon nitride (“SiNx”) or silicon oxide (“SiOx”), an organic insulating material, or a low dielectric insulating material. The dielectric constant of the low dielectric organic material is below 4.0, and examples thereof include a-Si:C:O and a-Si:O:F formed by plasma enhanced chemical vapor deposition (“PECVD”). The passivation layer 180 may be made of a photosensitive organic insulating material, and the surface of the passivation layer 180 may be flat. The passivation layer 180 may be formed of a dual-layered structure including a lower inorganic layer and an upper organic layer for protecting the exposed portion of the semiconductor 154 and making the best use of the merit of the organic layer semiconductor. The passivation layer 180 has a contact hole 185 exposing the output terminal electrode 175.

A pixel electrode 191 is formed on the passivation layer 180. The pixel electrodes 191 are physically and electrically connected to respective output terminal electrodes 175 through the contact hole 185, and are made of a transparent conductive material such as IZO and ITO or a reflective metal such as aluminum or silver, or alloys thereof.

A partition 360 is formed on the passivation layer 180. The partition 360 surrounds the pixel electrodes 191 like a bank to define openings, and is made of an organic insulating material or an inorganic insulating material.

An organic light emitting member 370 is formed on the pixel electrodes 191 and disposed in the openings defined by the partition 360.

The organic light emitting member 370, as shown in FIG. 4, has a multilayered structure including a light emission layer EML and supplementary layers for improving the luminous efficiency of the light emission layer EML. The supplementary layers include an electron transport layer ETL and a hole transport layer HTL for maintaining the balance between electrons and holes, and an electron injecting layer EIL and a hole injecting layer HIL for enhancing the injection of electrons and holes, respectively. However, the supplementary layers may be omitted in alternative exemplary embodiments.

Referring again to FIG. 3, an auxiliary electrode 382 made of a conductive material having low resistivity, such as a metal, is formed on the partition 360.

A common electrode 270 supplied with a common voltage Vss is formed on the partition 360, the organic light emitting member 370 and the auxiliary electrode 382. The common electrode 270 is made of a reflective metal such as Ca, Ba, Al, and the like, or a transparent conductive material such as ITO and IZO.

The auxiliary electrode 382 supplements the conductivity of the common electrode 270 by contact with the common electrode 270, thereby preventing distortion of the voltage of the common electrode 270.

A transparent common electrode 270 and an opaque pixel electrode 191 are applicable to a top emission type of organic light emitting diode display, which displays an image upward of the display panel 300. On the contrary, a transparent pixel electrode 191 and an opaque common electrode 270 are applicable to a bottom emission type of organic light emitting diode display, which displays an image downward of the display panel 300.

The pixel electrode 191, the organic light emitting member 370 and the common electrode 270 form the organic light emitting diode LD as shown in FIG. 2. The pixel electrode 191 and the common electrode 270 serve as an anode and a cathode, respectively. Alternatively, the pixel electrode 191 and the common electrode 270 serve as a cathode and an anode, respectively. The organic light emitting diode LD yields light of the primary colors according to the material of the organic light emitting member 370. The primary colors include, for example, three primary colors such as red, green and blue, and a desired color is displayed by the spatial summation of the three primary colors.

A more detailed structure of an organic light emitting diode display according to one exemplary embodiment of the present invention will be described in more detail with reference to FIGS. 5 to 8.

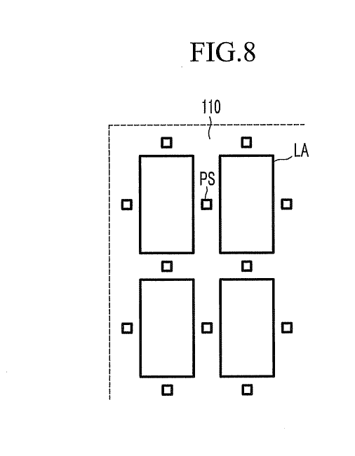

FIG. 5 is a schematic plan view layout of an organic light emitting diode display according to one exemplary embodiment of the present invention. FIG. 6 is an equivalent circuit diagram of an example of one pixel of an organic light emitting diode display according to one exemplary embodiment of the present invention FIG. 7 is a cross-sectional view showing the organic light emitting diode display as shown in FIG. 5, taken along line VII-VII. FIG. 8 is a schematic plan view layout of an organic light emitting diode display according to another exemplary embodiment of the present invention.

Referring to FIG. 5, the organic light emitting diode display according to one exemplary embodiment of the present invention includes a plurality of light emitting areas LA and photosensors PS formed on a substrate 110.

The plurality of light emitting areas LA are arranged in a matrix, but is not limited thereto.

The photosensors PS are arranged in spaces between the light emitting areas LA, and are positioned at substantially equal distances from four light emitting regions LA. In other words, with respect to one light emitting area LA, four photosensors PS are positioned around the four corner parts of one light emitting area LA.

Referring to FIG. 6 and FIG. 7, one example of the photosensors PS will be described in more detail.

Referring to FIG. 6, each pixel PX, for example a pixel connected to the scanning signal line Gᵢ of the i-th pixel row and the image data line Dⱼ and sensing data line Pⱼ of the of the j-th pixel row, includes an organic light emitting diode LD, a driving transistor Qd, a sensing transistor Qp, first and second capacitors C1 and C2, and first and second switching transistors Qs1 and Qs2.

The organic light emitting diode LD, driving transistor Qd, first capacitor C1, and first switching transistor Qs1 are arranged on light emitting areas LA. The elements are the same as those described in FIG. 2, so a description thereof will be omitted.

The sensing transistor Qp is a three-terminal element having a control terminal connected to a control voltage line Ln, an input terminal connected to the second switching transistor Qs2, and an output terminal connected to the scanning signal line Gᵢ₊₁ (hereinafter, the next scanning signal line) of the (i+1)-th pixel row. A channel portion semiconductor of the sensing transistor Qp is positioned below the organic light emitting diode LD, and it receives light emitted from the organic light emitting diode LD to form a photocurrent and sends the photocurrent to the output terminal according to a voltage difference between the input terminal and the output terminal of the sensing transistor Qp.

The second switching transistor Qs2 is also a three-terminal element, having a control terminal and an input terminal connected to the scanning signal line Gᵢ and the sensing data line Pⱼ, respectively, and an output terminal connected to the sensing transistor Qp. The second switching transistor Qs2 transmits a sensing reference voltage from the sensing data line Pⱼ to the second capacitor C2.

The second capacitor C2 is connected between the control terminal and the input terminal of the sensing transistor Qp, and is charged with the sensing reference voltage supplied from the second switching transistor Qs2. Further, as the photocurrent flows in the sense transistor Qp, the second capacitor C2 discharges a predetermined voltage corresponding to the intensity of the photocurrent.

Referring to FIG. 7, a control terminal electrode 124p is formed on an insulating substrate 110. An insulating layer 140 made of silicon nitride (“SiNx”) is formed on the control terminal electrode 124p.

A semiconductor 154p made of hydrogenated amorphous silicon (“a-Si”) or polycrystalline silicon (“polysilicon”) is formed on the insulating layer 140. A pair of ohmic contacts 163p and 165p made of silicide or n+ hydrogenated a-Si heavily doped with an n-type impurity are formed on the semiconductor 154p.

An input terminal electrode 173p and an output terminal electrode 175p are formed on the ohmic contact 163p and 165p and the insulating layer 140.

The input terminal electrode 173p and the output terminal electrode 175p are separate from each other and disposed at both sides of the gate electrode 124p. The gate electrode 124p, the input terminal electrode 173p and the output terminal electrode 175p define the sensing transistor Qp along with the semiconductor 154p, and its channel is formed on the semiconductor 154p between the input terminal electrode 173p and the output terminal electrode 175p.

The semiconductor 154p includes an exposed portion, which is not covered with the input terminal electrode 173p and the output terminal electrode 175p. A passivation layer 180 is formed on the input terminal electrode 173p, the output terminal electrode 175p, the exposed portion of the semiconductor 154p and the insulating layer 140. A pixel electrode 191 is formed on the passivation layer 180. A partition 360 is formed on the passivation layer 180. An organic light emitting member 370 is formed on the pixel electrodes 191. A common electrode 270 is supplied with a common voltage Vss and is formed on the partition 360 and the organic light emitting member 370. Here, the passivation layer 180, pixel electrode 191, partition 360, organic light emitting member 370 and common electrode 270 are the same members as those as shown in FIG. 3, and the areas where the organic light emitting member 370 are formed constitute light emitting areas LA.

As shown by the arrow in FIG. 7, light released by the emission of the organic light emitting member 370 is reflected on the common electrode 270, and flows into the exposed semiconductor 154p. Hence, the exposed semiconductor 154p forms a photocurrent, and sends the photocurrent according to a voltage difference between the input terminal 173p and the output terminal 175p. Subsequently, the common electrode 270 serves as a light guide for guiding the light released from the organic light emitting member 370 into the sensing transistor Qp. However, the present invention is not limited thereto, and a variety of members which are capable of serving as a light guide can be selected.

The upper side of the exposed portion of the semiconductor 154p is covered with the common electrode 270, and the lower side thereof is covered with the control terminal electrode 124p, thereby preventing the introduction of external light.

Referring to FIG. 8, an organic light emitting diode display according to another exemplary embodiment of the present invention will be described.

FIG. 8 is a schematic plan view layout of an organic light emitting diode display according to another exemplary embodiment of the present invention.

The organic light emitting diode display of FIG. 8 also includes a plurality of light emitting areas LA arranged in a matrix on a substrate 110 and a plurality of photosensors PS formed around the light emitting areas LA.

However, unlike FIG. 5, in the organic light emitting diode display of FIG. 8, the photosensors PS are formed not at the corner portions of each light emitting area LA, but near the center of each side of the light emitting areas LA. Thus, one photosensor PS is positioned at substantially equal distances from two light emitting areas LA.

Referring to FIG. 1 again, the gray voltage generator 700 generates a set of gray voltages (or a set of reference gray voltages) related to the luminance of pixels PX based on gamma control data GCD from the signal controller 600. The gamma control data GCD is a digital value corresponding to an image data voltage with respect to a maximum gray level (hereinafter, a maximum image data voltage). Alternatively, the gamma control data GCD may have a plurality of digital values corresponding to each gray voltage which are stored in a lookup table (not shown). In addition, the gray voltage generator 700 is able to generate a gray voltage independently based on a gamma curve for each primary color. In this case, the gamma control data GCD is also defined for each primary color.

The scanning driver 400 is connected to the scanning signal lines G₁-Gₙ₊₁ of the display panel 300, and applies a scanning signal comprised of a combination of a gate-on voltage Von for turning on the first and second switching transistors Qs1 and Qs2 and a gate-off voltage Voff for turning off the first and second switching transistors Qs1 and Qs2 to the scanning signal lines G₁-Gₙ₊₁.

The image data driver 500 is connected to the image data lines D₁-Dₘ, selects a gray voltage from the gray voltage generator 700, and applies the gray voltage as an image data voltage to the image data lines D₁-Dₘ. However, in a case where the gray voltage generator 700 does not provide all voltages for all gray levels but only a predetermined number of reference gray voltages, the image data driver 500 divides the reference gray voltages to produce gray voltages for all of the gray levels, and selects the image data voltage among them.

The luminance detector 800 is connected to the sensing data lines P₁-Pₘ of the display panel 300, and applies a sensing reference voltage to the sensing data lines P₁-Pₘ. Referring to FIGS. 1 and 6, the sensing reference voltage is applied to the second capacitor C2 through the second switching transistor Qs2, and the second capacitor C2 charged with a predetermined voltage is charged again with the sensing reference voltage. The luminance detector 800 detects the difference between the voltage charged in the second capacitor C2, e.g., the sensing reference voltage, and the predetermined voltage, and produces digital luminance information DSN by performing particular signal processing on the detected voltage, and then transmits the digital luminance information DSN to the signal controller 600. The detected voltage corresponds to the luminance yielded by the organic light emitting diode LD. The luminance detector 800 is able to determine luminance information by detecting a current flowing into the second capacitor C2 or a quantity of electric charge to be charged therein.

The signal controller 600 controls operations of the scanning driver 400, the image data driver 500 and the luminance detector 800.

Each of the drivers 400, 500, 600, 700 and 800 may be directly mounted as at least one integrated circuit (“IC”) chip mounted on the display panel 300 or on a flexible printed circuit film (not shown) in a tape carrier package (“TCP”) type, which are attached to the display panel 300, or may be mounted on a separate printed circuit board (not shown). Alternatively, the drivers 400, 500, 600, 700 and 800 may be directly integrated into the display panel 300 along with the signal lines G₁-Gₙ₊₁ and D₁-Dₘ, the thin film transistors Qs1, Qs2, Qd, and Qp, and so on. Further, the drivers 400, 500, 600, 700 and 800 may be integrated as a single chip. In this case, at least one of them or at least one circuit device constituting them may be located outside of the single chip.

Now, the operation of the organic light emitting diode display will be described in more detail.

The signal controller 600 is supplied with input image signals R, G and B and input control signals controlling the display thereof from an external graphics controller (not shown). The input image signal R, G and B contain luminance information of each pixel, and each luminance has a given number of gray levels, for example, 1024 (=2¹⁰), 256 (=2⁸), or 64 (=2⁶) gray levels. Examples of the input image signals include a vertical synchronization signal Vsync, a horizontal synchronization signal Hsync, a main clock signal MCLK and a data enable signal DE.

After suitably processing the image signals R, G and B for the operation of the display panel 300 and image data driver 500 on the basis of the input image signals R, G and B and the input control signals, and generating scanning control signals CONT1, image data control signals CONT2, luminance detection control signals CONT3, and gamma control data GCD, the signal controller 600 transmits the scanning control signals CONT1 to the scanning driver 400, and transmits the image data control signals CONT2 and the processed image signals DAT to the image data driver 500. The output image signal DAT is a digital signal, and has a given number of values (or gray levels). In addition, the signal controller 600 transmits the luminance detection control signals CONT3 to the luminance detector 800 and the gamma control data GCD to the gray voltage generator 700.

The scanning control signals CONT1 include a scanning start signal STV for instructing to start scanning and at least one clock signal for controlling the output cycle of the gate-on voltage Von. The scanning control signal CONT1 may further include an output enable signal OE for defining the duration of the gate-on voltage Von.

The image data control signals CONT2 include a horizontal synchronization start signal STH for informing of start of the transmission of the image signals DAT for a row of pixels, a load signal LOAD for instructing to apply image data voltages to the image data lines D₁-Dₘ, and a data clock signal HCLK.

In response to the image data control signals CONT2 from the signal controller 600, the image data driver 500 receives image signals DAT for a row of pixels PX, converts the image signals DAT to analog data voltages by selecting gray voltages corresponding to the respective image signals DAT, and then applies them to the corresponding image data lines D₁-Dₘ. Alternatively, the image data driver 500 may divide the reference gray voltage from the gray voltage generator 700 to generate gray voltages, and may apply the gray voltages to the image data lines D₁ to Dₘ as image data voltages.

The scanning driver 400 applies a gate-on voltage Von to the scanning signal lines G₁-Gₙ in response to the scanning control signals CONT1 from the signal controller 600 to thus turn on the first switching transistor Qs1 connected to the scanning signal lines G₁-Gₙ. Then, the image data voltage applied to the image data lines (D₁-Dₘ) is applied to the control terminal of the corresponding driving transistor Qd and the first capacitor C1 through the turned-on first switching transistor Qs1, and the first capacitor C1 is charged with the image data voltage. The voltage charged in the first capacitor C1 is maintained during one frame even if a scanning signal becomes a gate-off voltage Voff and the first switching transistor Qs1 of the first capacitor C1 is turned off, thereby keeping the control terminal voltage of the driving transistor Qd constant.

The driving transistor Qd sends an output current I_{LD}, whose magnitude is controlled according to an image data voltage, to the organic light emitting diode LD, and the organic light emitting diode LD displays a corresponding image by emitting light at an intensity which varies according to the magnitude of the current I_{LD}.

By repeating the above-mentioned procedure each horizontal period (which is denoted by “1H” and is equal to one period of the horizontal synchronizing signal Hsync and the data enable signal DE), all scanning signal lines G₁-Gₙ are sequentially supplied with the gate-on voltage Von, thereby applying the data signals to all of the pixels to display images of one frame.

Since the scanning signal line Gₙ₊₁ is connected to the sensing transistor Qp of the last pixel row, and is not connected to the switching transistors Qs1 and Qs2, there is no need to apply the gate-on voltage Von to the scanning signal lines Gₙ₊₁. However, the gate-on voltage Von may be applied in order to exactly provide the same conditions as of other pixel rows.

Meanwhile, the luminance detector 800 applies a sensing reference voltage to the sensing data line P₁-Pₘ in response to the luminance detection control signal CONT3 from the signal controller 600.

If the scanning signal applied to one scanning signal line Gᵢ becomes the gate-on voltage Von, the second switching transistor Qs2 of the corresponding pixel row, as well as the first switching transistor Qs1 thereof, are turned on. The sensing reference voltage applied to the sensing data lines P₁-Pₘ is applied to the input terminal of the corresponding sensing transistor Qp and the second capacitor C2 through the turned-on second switching transistor Qs2, and the second capacitor C2 is charged with the sensing reference voltage.

After the 1 horizontal period, the scanning signal applied to the scanning signal line Gᵢ becomes the gate-off voltage Voff, and the scanning signal applied to the scanning signal line Gᵢ₊₁ becomes the gate-on voltage Von. Then, the second switching transistor Qs2 is turned off, so that the second capacitor C2 and the input terminal of the sensing transistor Qp become floating, and the gate-on voltage Von is applied to the output terminal of the sensing transistor Qp.

After the 1 horizontal period, when the scanning signal applied to the scanning signal line Gᵢ₊₁ becomes the gate-off voltage Voff, the output terminal voltage of the sensing transistor Qp again becomes the gate-off voltage Voff. Then, a photocurrent of the sensing transistor Qp formed by the emission of the organic light emitting diode LD flows from the input terminal of the sensing transistor Qp toward the output terminal thereof, and the sensing reference voltage charged in the second capacitor C2 starts to be discharged. In the next frame, the discharge continues until the gate-on voltage Von is applied again to the scanning signal line Gᵢ and the discharged voltage corresponds to the luminance yielded by the organic light emitting diode LD. When the scanning signals become the gate-on voltage Von, the sensing reference voltages applied to the sensing data lines P₁-Pₘ are charged again in the second capacitor C2. The luminance detector 800 detects the magnitude of the voltage difference between the voltage charged in the second capacitor C2, e.g., the voltage left after being discharged depending on the photocurrent, and the sensing reference voltage, produces digital luminance DSN corresponding to the luminance yielded by the organic light emitting diode LD, and then transmits them to the signal controller 600.

The signal controller 600 produces gamma control data GCD based on the difference between a target luminance and a measured luminance, and sends the gamma control data GCD to the gray voltage generator 700. The gamma control data GCD for the difference between the target luminance and the measured luminance can be stored in a lookup table (not shown) or the like, and the measured luminance can be extracted from the digital luminance information DSN. For example, the maximum image data voltage can be set to 10 to 15V, and when the luminance decreases, the luminance can be compensated by the gray voltage which is increased by an increase in maximum image data voltage. Alternatively, the luminance can be compensated by a change in gray voltage. Alternatively, the respective luminance for each primary color is measured so as to compensate for the luminance for each primary color.

As seen above, even if the luminance is lowered by a variation in threshold voltage, the luminance can be compensated by a change in gray voltage caused by detecting the luminance by the sensing transistor Qp or the like.

The variation of the threshold voltage is carried out for a long period of time, so luminance detection and luminance compensation do not need to be performed for each frame, but they are performed at predetermined time intervals. Additionally, there is no need to detect the luminance for all pixels PX of the display panel 300, and sample pixels can be set so that the luminance may be detected therefrom, and the gamma control data GCD can be produced based on the detected luminance.

Preferably, the second capacitor C2 is designed so that the second capacitor C2 can be fully charged with the sensing reference voltage during one horizontal period, and the sensing transistor Qp and the second capacitor C2 are designed so that the voltage which is discharged, depending on a photocurrent, may be smaller than the sensing reference voltage. The sensing reference voltage and the gate-off voltage Voff are set such that the photocurrent flows from the input terminal of the sensing transistor Qp to the output terminal thereof. For example, the sensing reference voltage may be set to about 5V, and the gate-off voltage Voff may be set to about −8V.

While the foregoing description has been made with respect to a case where the photosensors PS include the sensing transistor Qp, the photosensors PS may employ various other photosensors.

The operation of the photosensors PS can be implemented along with the operation in which all of the organic light emitting diodes LD emit light according to an image data voltage transmitted through the driving transistor Qd, thereby displaying images. That is, the photosensors PS can sense light and the luminance detector 700 can detect luminance while the organic light emitting diodes LD of all of the pixels PX emit light to display images. At this time, if at least one of the photosensors PS around one light emitting area LA measures the luminance of one light emitting area LA, and takes the average of the luminance or adds up the luminance, the luminance measurement can be performed more accurately. By this, even if a failure occurs with any one of the photosensors PS around one light emitting area LA, the other photosensors PS play their role, thereby preventing the luminance measurement from being stopped. Additionally, one photosensor PS can be used for the measurement of the luminance of a plurality of light emitting areas LA.

In the meantime, a unit light emitting region including the light emitting area LA of which luminance is desired to be measured, among the plurality of light emitting areas LA, is designated, and black data is applied to the other light emitting regions except the unit light emitting region to display them as black, so that the unit light emitting region can be made luminous. At this time, the unit light emitting region may include at least one light emitting area LA and a different light emitting area LA is allocated to the unit light emitting region each time, so that the luminance of all the light emitting areas LA can be sequentially measured.

In the above description, the display of an image by making the light emitting areas LA luminous and the measuring of the luminance of the light emitting areas LA in the photosensors PS are carried out.

However, as an alternative, the light emitting areas LA can be divided by an image display time and a luminance measurement time for sequentially making them luminous. That is, the measuring of luminance can be performed between the two unit times for displaying images by making the light emitting areas LA luminous. This method can be performed in units of frames displaying an image, or in units of one row of the light emitting areas LA. At this time, in the measuring of a luminance to be performed between units of each frame or each row, the measuring can be performed by modifying the light emitting areas LA measuring a luminance. Accordingly, if a certain number of frames has passed, or a certain row has passed, the luminance of all of the light emitting areas LA can be measured. By this, it is possible to prevent the time for measuring the luminance of the light emitting areas LA from affecting the driving of the display device.

According to the present invention, even if there is a variation in the properties of the photosensors, a variation of the threshold voltage of the amorphous silicon thin film transistor can be compensated by accurate measurement and compensation of the luminance of the light emitting areas.

While this invention has been described in connection with what is presently considered to be practical exemplary embodiments, it is to be understood that the present invention is not limited to the disclosed exemplary embodiments, but, on the contrary, is intended to cover various modifications and equivalent arrangements included within the spirit and scope of the appended claims.

What is claimed is:

1. A display device, comprising:
a plurality of light emitting elements arranged in a matrix form;
a plurality of driving transistors which supply a driving current to the light emitting elements; and
photosensors which sense the amount of light emitted from the light emitting elements and produce a sense signal according to the sensed amount of light,
wherein the photosensors are positioned at a space between the plurality of light emitting elements.

2. The display device of claim 1, wherein the photosensors are positioned at substantially equal distances from four of the plurality of light emitting elements.

3. The display device of claim 1, wherein the photosensors are positioned at substantially equal distances from two of the plurality of light emitting elements.

4. The display device of claim 1, further comprising a light guide member which transmits light from the light emitting elements to the photosensors.

5. The display device of claim 4, wherein the light guide member comprises a common electrode formed on the light emitting elements.

6. The display device of claim 5, wherein the common electrode is one of transparent and opaque according to an emission type of the display device.

7. The display device of claim 4, wherein the plurality of light emitting elements is disposed intermediate the light guide member and the photosensors.

8. The display device of claim 1, further comprising a light shielding part shielding light entering the photosensors.

9. The display device of claim 1, wherein the photosensors comprise a sensing transistor forming a photocurrent according to the light emission of the

10. The display device of claim 9, further comprising:
a plurality of first capacitors charging an image data voltage corresponding to the driving current; and
a plurality of second capacitors charging a sensing reference voltage and discharging a predetermined voltage corresponding to the photocurrent.

11. The display device of claim 10, further comprising:
a plurality of first switching transistors transmitting the image data voltage to the first capacitors and the driving transistor in response to a scanning signal; and
a plurality of second switching transistors transmitting the sensing reference voltage to the second capacitors and the sensing transistor in response to the scanning signal.

12. The display device of claim 11, further comprising:
a plurality of scanning signal lines connected to the first and second switching transistors, for connecting the scanning signal;
a plurality of image data lines connected to the first switching transistors, for transmitting the image data voltage; and
a plurality of sensing data lines connected to the second switching transistors, for transmitting the sensing reference voltage.

13. The display device of claim 12, further comprising a luminance detector connected to the sensing data lines which supplies the sensing reference voltage to the sensing data lines, and detects the magnitude of the voltage charged in the second capacitor to produce luminance information of the light emitting elements.

14. A method of driving a display device, the display device comprising first and second light emitting element groups each comprising at least one light emitting element, a driving transistor connected to the light emitting element, and at least one photosensor neighboring the light emitting element, the method comprising:
applying a data voltage to the driving transistor;
supplying a driving current depending on the data voltage to the light emitting element through the driving transistor to luminate the first light emitting element group among the plurality of light emitting elements;
generating sensing signals according to the light emission of the first light emitting element group by each of the photosensors;
displaying an image by the light emission of the second light emitting element group according to image information; and
detecting a luminance corresponding to the sensing signals generated from each of the photosensors, and compensating an image signal by comparison between the detected luminance and a target luminance.

15. The method of claim 14, further comprising averaging at least two of the sensing signals to detect the corresponding luminance.

16. The method of claim 15, wherein the displaying of an image and the generating of sensing signals are simultaneously performed.

17. The method of claim 16, wherein the displaying of an image and the producing of sensing signals may be performed in an alternating fashion.
